(19) United States
(12) Patent Application Publication
(10) Pub. No.: US 2026/0009886 A1
(43) Pub. Date: Jan. 8, 2026

(54) REDUCTION OF SCATTERING EFFECTS IN SYNTHETIC APERTURE RADAR WITH MACHINE LEARNING

(71) Applicant: Andro Computational Solutions, LLC, Rome, NY (US)

(72) Inventors: Jithin Jagannath, Oriskany, NY (US); Anu Jagannath, Oriskany, NY (US)

(21) Appl. No.: 19/263,124

(22) Filed: Jul. 8, 2025

Related U.S. Application Data
(60) Provisional application No. 63/668,536, filed on Jul. 8, 2024.

(51) Int. Cl. G01S 7/41; G01S 13/66; G01S 13/90

(52) U.S. Cl. CPC G01S 7/414; G01S 13/66; G01S 13/9027; G01S 7/417

(57) ABSTRACT

Embodiments of the disclosure provide a method and system to reduce scattering effects such as multiplicative speckle noise in synthetic aperture radar (SAR) with machine learning. Methods of the disclosure include converting an input image into an enhanced image via an encoder-decoder network having an adversarial learning system. Methods of the disclosure also include identifying a target within the enhanced image by separating the enhanced image into a plurality of segments via a tracker module having at least a spatial attention layer, a channel attention layer, and a depth-wise convolution.

### PRIORITY CLAIM

This application claims priority to US Provisional Application Serial No. 63/668,536, REDUCTION OF SCATTERING EFFECTS IN SYNTHETIC APERTURE RADAR WITH MACHINE LEARNING filed on July 8, 2024, the contents of which are hereby incorporated by reference.

### BACKGROUND

### 1. TECHNICAL FIELD

The present disclosure relates to imaging technologies, including processing synthetic aperture radar (SAR) to identify and/or track objects.

### 2. BACKGROUND ART

Synthetic Aperture Radar (SAR) is a remote sensing technology that uses radar waves to create high-resolution images of the Earth's surface. It works by transmitting radar pulses from a moving platform (like an aircraft or satellite) and then processing the returning echoes to generate images. Such images are referred to as "synthetic" because the radar's motion is used to create a virtual, larger antenna, which allows for much finer image resolution than a real antenna of the same size could achieve.

### SUMMARY

The illustrative aspects of the present disclosure are designed to solve the problems herein described and/or other problems not discussed. All aspects, examples and features mentioned below can be combined in any technically possible way.

Aspects of the disclosure provide a method including: converting an initial image into an enhanced image via an encoder-decoder network implemented with an adversarial learning system that is trained with real and synthetic imagery; and identifying a target within the enhanced image by separating the enhanced image into a plurality of segments via a tracker module that includes a depth-wise convolution, a spatial attention mechanism and a channel attention mechanism.

Another aspect includes a system, including: an encoder-decoder network configured to convert an initial image into an enhanced image, wherein the encoder- decoder network is implemented with an adversarial learning system that is trained with real and synthetic imagery; and a tracker module configured to receive the enhanced image and identify a target within the enhanced image by separating the enhanced image into a plurality of segments via a depth-wise convolution of the enhanced image, wherein the tracker module includes at least a spatial attention mechanism and a channel attention mechanism.

Another aspect of the disclosure includes any of the preceding aspects, and wherein the encoder-decoder network is an autoencoder network.

Another aspect of the disclosure includes any of the preceding aspects, and wherein the encoder-decoder network and the tracker module are implemented on a field programmable gate array (FPGA).

Another aspect of the disclosure includes any of the preceding aspects, and wherein the initial image includes a synthetic aperture radar (SAR) image.

Another aspect of the disclosure includes any of the preceding aspects, and wherein the tracker module implements one of pruning, quantization, and low-rank factorization to compress a model size of the enhanced image.

Another aspect of the disclosure includes any of the preceding aspects, and wherein the encoder-decoder network is an autoencoder network.

Another aspect of the disclosure includes any of the preceding aspects, and wherein the encoder-decoder network is communicatively coupled to the tracker module via a field programmable gate array (FPGA).

Another aspect of the disclosure includes any of the preceding aspects, and wherein the initial image includes a synthetic aperture radar (SAR) image.

Another aspect of the disclosure includes any of the preceding aspects, and wherein the tracker module implements one of pruning, quantization, and low-rank factorization to compress a model size of the enhanced image.

### BRIEF DESCRIPTION OF THE DRAWINGS

FIG. 1 shows an example of a field programmable gate array (FPGA) based implementation of a SAR processing system to reduce scattering effects in synthetic aperture radar, usable with systems and methods according to embodiments.

FIG. 2 shows an image enhancer according to the disclosure.

FIG. 3shows a generator and discriminator according to embodiments.

FIG. 4depicts an autoencoder according to embodiments.

FIG. 5depicts a tracker module according to embodiments.

FIG. 6depicts an illustrative computing system according to embodiments.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described to best explain the principles of the disclosure and the practical application, and to enable others of ordinary skill in the art to understand the disclosure for various embodiments with various modifications as are suited to the particular use contemplated.

A technical challenge affecting SAR imagery in various applications relates to scattering nets. Scattering nets are devices in an operating area which intentionally mask the radar returns of an object to obscure its true identity. Scattering nets can create complex backscatter patterns that differ from the object they are masking, adding false or misleading reflections and clutter to the SAR image. Scattering nets are an obstacle to accurately identifying or tracking certain objects. The mitigation of backscatter patterns created by scattering nets, in particular, are more challenging to mitigate as they introduce complex and intentional patterns.

Another challenge faced by SAR image processing is speckle noise. Speckle noise is an inherent multiplicative noise present in SAR imagery, caused by the coherent nature of the radar signal. Speckle noise results from the constructive and destructive interference of the returning radar waves from multiple scatterers within a single resolution cell. This noise gives the SAR images a grainy appearance and can significantly reduce the quality and interpretability of the imagery.

Embodiments of the disclosure improve SAR imagery processing and Automatic Target Acquisition (ATA) by implementing machine learning and field programmable gate array (FPGA) technologies.

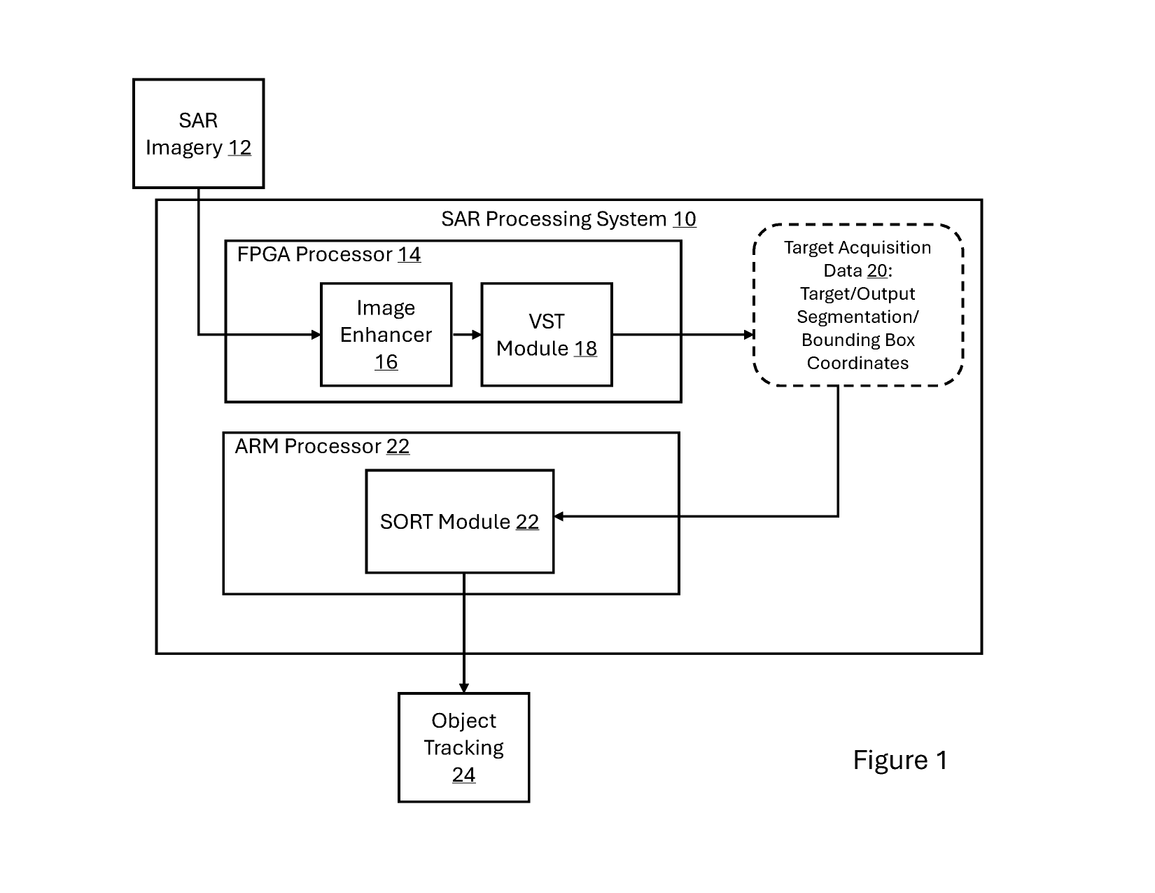

Referring to FIG. 1, a SAR processing system 10 is shown. Associated systems and methods of the disclosure may be implemented, e.g., using a set of modules, including convolutional neural networks (CNNs) and other systems. In this illustrative embodiment, system 10 is implemented with a field programmable gate array (FPGA) processor 14 and an ARM processor 22. (An ARM processor 22 is a type of CPU that uses a RISC (Reduced Instruction Set Computing) architecture to allow for faster processing.) It is, however, understood that other hardware, software, or firmware components could be utilized in their place.

During non-training operations, FPGA processor 14 receives SAR imagery 12 as an input and is initially processed by an image enhancer 16. SAR imagery 12, for example, may include a sequence of frames containing image (e.g., pixel) data. Image enhancer 16 utilizes an advanced attentional denoising-backscatter reversing autoencoder (ADeBRA), implemented and trained with an adversarial learning system. Image enhancer 16 is dedicated to processing SAR imagery 12 and removing artifacts, such as backscatter effects and multiplicative speckle noise, caused by objects including reflectors and scattering nets. The ADeBRA utilizes attention mechanisms to focus on significant image features, ensuring high-quality denoised outputs. The use of adversarial learning during operations, among other benefits, serves to identify and reverse the backscatter effects introduced by scattering nets and reflectors in an area of operation.

The output of the image enhancer 16 is fed to a vision-seg-tracker (VST) module 18. The VST module 18 includes a multi-task architecture that generates target acquisition data 20 using SAR imagery segmentation. An example of such a system is described in US Patent 10,721,162, entitled "Routing data through distributed communications network," issued on July 21, 2020, the contents of which are hereby incorporated by reference. The VST module 18, when implemented, may follow a platform-aware design process that leverages spatial and channel attention layers along with depth-wise convolution operations to support the architecture that facilitates FPGA deployment. Further, the VST module 18 acquires object(s) of interest (i.e., targets) in the presented SAR imagery 12 and estimates bounding box coordinates. These coordinates can be fed into another module that, e.g., runs on the ARM processor 22, i.e., a Simple Online and Realtime Tracking (SORT) module 22, which outputs object tracking 24 from frame to frame. By integrating image segmentation and acquisition in a single machine learning model, system 10 maintains a persistent lock on objects of interest, ensuring accurate tracking across multiple frames.

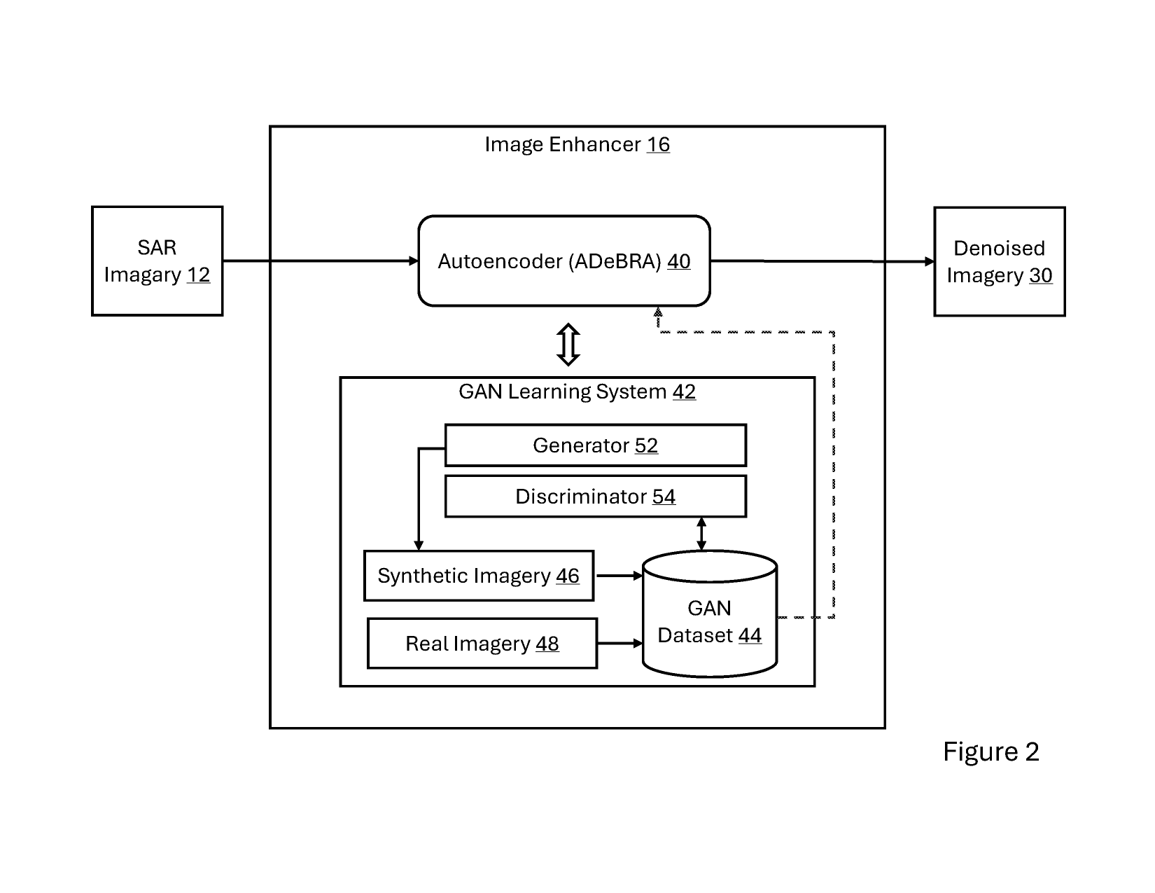

As shown in FIG. 2, image enhancer 16 includes ADeBRA (i.e., autoencoder) 40 which includes or interacts with a Generative Adversarial Network (GAN) learning system 42 (i.e., GAN system 42) to facilitate training of the autoencoder 40. In particular, during training, GANs are utilized to distinguish between true targets and false patterns introduced in SAR images, e.g., by scattering nets, to refine a GAN dataset that will help mitigate backscatter effects from scattering nets and the like in SAR imagery 12.

Embodiments of the disclosure use the GAN system 42 to train and augment GAN dataset 44 with real-world problems, such as speckle noise and other effects of scattering nets and reflectors. The augmented GAN datasets 44 are then used to enhance the autoencoder 40. Using a GAN system 42 to simulate the effects of scattering nets in SAR images 12 involves providing a sophisticated model that can learn and reproduce the complex interference patterns introduced by scattering nets.

The GAN system 42 includes two neural network components: a generator 52 and a discriminator 54, which work in tandem to produce realistic scattering effects and refine the generation process using both synthetic imagery 46 and real imagery 48. Integrated attention layers within both the generator 52 and discriminator 54 significantly enhance the GAN system's performance. These mechanisms enable the system to focus on relevant spatial features, improving the realism of the generated patterns. Advanced loss functions such as Wasserstein loss with gradient penalty (WGAN-GP) also may be implemented to stabilize training and improve the quality of the generated images.

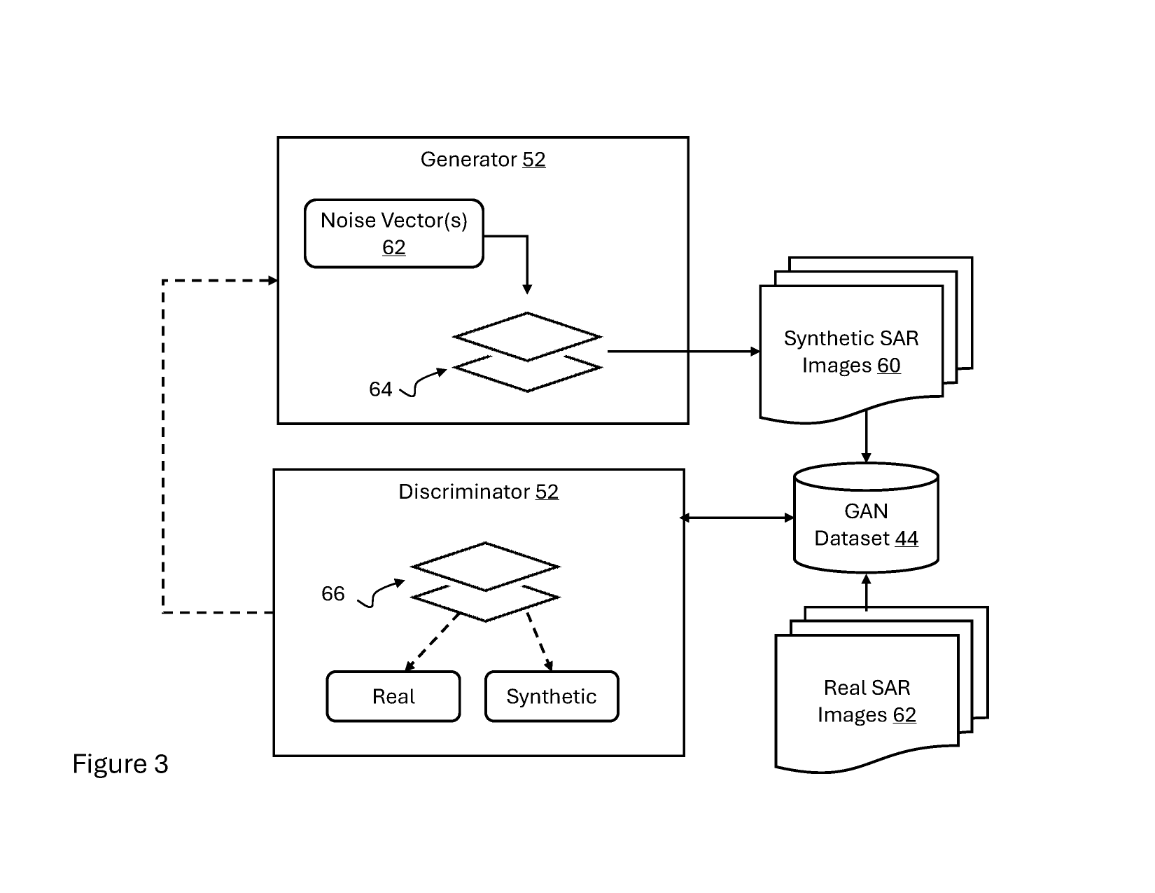

As shown in FIG. 3, the generator 52, during training operations, functions to create synthetic SAR images 60 that replicate the appearance of images affected by scattering nets. The generator 60 starts with a noise vector 62, typically sampled from a Gaussian distribution, and transforms this vector into a synthetic SAR image 60 through a series of transposed convolutional layers 64 (also known as deconvolutional layers). Each layer 64 in the generator 52 increases the spatial resolution of the image while learning to introduce the intricate patterns characteristic of scattering nets.

The discriminator's role is to differentiate between real SAR images 62 affected by scattering nets and synthetic SAR images 60 generated by the generator 52. The discriminator 52 employs a series of convolutional layers 66 to extract features and classify the input images as either real or synthetic (i.e., falsified). The discriminator 52 is trained to maximize its ability to distinguish between the two types of images, providing feedback to the generator 52 to improve its synthetic image production. By leveraging the adversarial training framework and integrating attention mechanisms, GAN system 42 can produce highly realistic and complex interference patterns, providing valuable training data for developing more effective SAR analysis models. The synthetic images help the autoencoder 40 learn to handle diverse backscatter patterns and noise profiles encountered in real-world scenarios.

The autoencoder 40 (FIG. 2) is an encoder-decoder network designed to convert a SAR image into an enhanced (denoised) image by removing artifacts such as backscatter effects and speckle noise. The autoencoder 40 enhances the interpretability and utility of SAR imagery 12. The autoencoder 40 operates via convolutional neural network (CNN) architectures that integrate cutting-edge attention mechanisms with adversarial learning techniques. This approach addresses the unique challenges posed by SAR imagery, including speckle noise and distortions caused by backscatter, which often obscure crucial details essential for environmental monitoring, disaster response, and military surveillance applications. Convolutional neural networks may be distinguished from other neural network models, e.g., by including individual nodes in each layer which respond to inputs in a restricted region of a simulated space known as "a receptive field." The receptive fields of different nodes and/or layers can partially overlap such that they together form a depiction of a visual field (e.g., an environment and certain objects or elements therein, represented in two-dimensional or three-dimensional space). The response of an individual node to inputs within its receptive field can be approximated mathematically by a convolution operation.

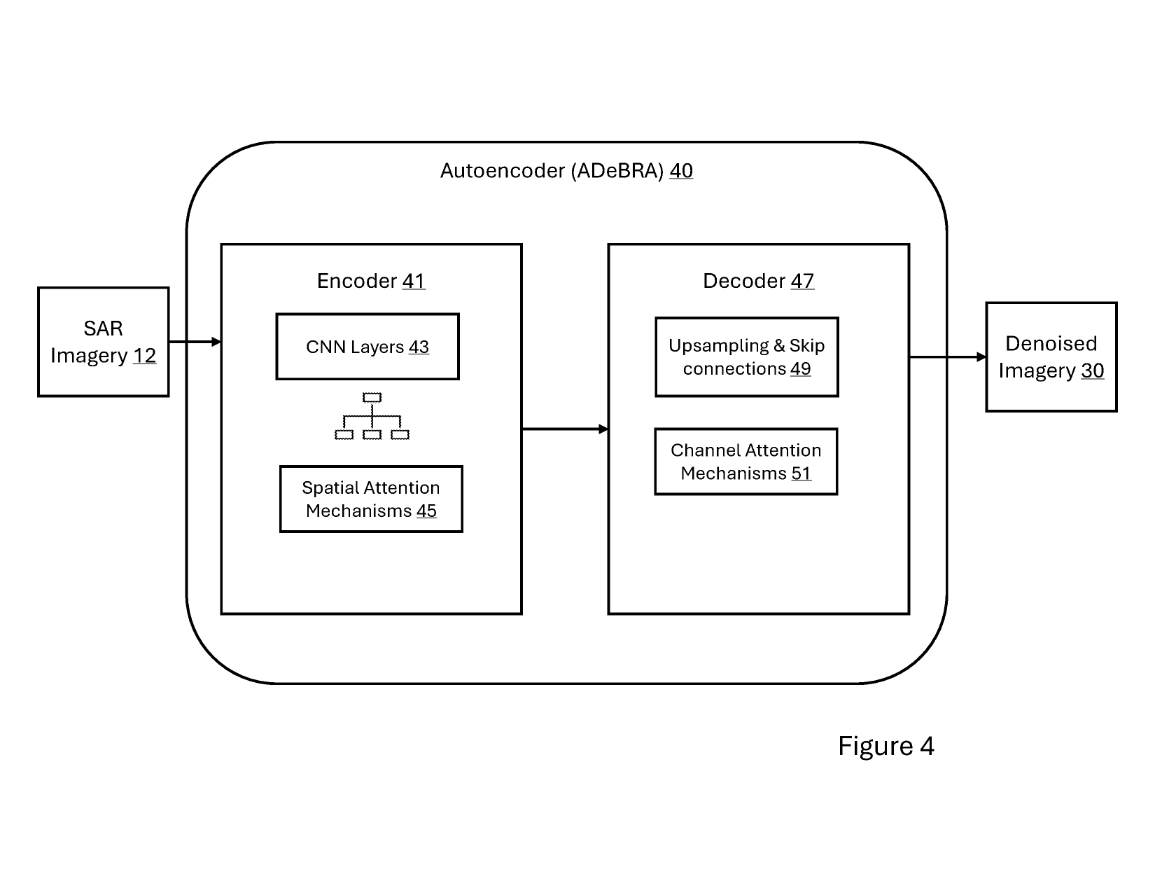

As shown in FIG. 4, the architecture of autoencoder 40 implements an encoder- decoder structure enriched with attentional layers positioned to capture and amplify critical features within SAR imagery 12 while mitigating the impact of backscatter artifacts. The encoder component 41 utilizes deep convolutional layers 43 to extract hierarchical representations from raw SAR imagery data, facilitating the encoding of spatial information into a compact latent space representation. This encoding phase is complemented by spatial attention mechanisms 45 that dynamically adapt to highlight regions of interest rich in relevant information, such as terrain features or infrastructure, while simultaneously suppressing areas affected by noise and backscatter.

In the decoder phase 47, which involves the reconstruction of denoised SAR images from the encoded latent space, autoencoder 40 employs upsampling layers and skip connections 49 to restore spatial resolution and preserve fine-grained details. Channel attention mechanisms 51 are integrated into the decoding process to enhance feature extraction by prioritizing informative channels that contribute significantly to the denoising process. This dual attentional strategy enhances the fidelity of reconstructed SAR images and enables retention of essential structure and context. These benefits empower related tasks, such as target detection, land cover classification, and change detection.

ADeBRA differs from conventional autoencoders by providing adversarial learning through GAN system 42 to generate synthetic SAR images that simulate diverse backscatter patterns and noise profiles encountered in real-world scenarios. By training the autoencoder component(s) with a blend of synthetic and real SAR data, ADeBRA achieves robustness and generalization, enabling it to effectively handle a wide spectrum of environmental conditions and SAR sensor specifications. This approach not only circumvents the limitations of sparse or proprietary datasets, but also enhances scalability and adaptability across different operational contexts.

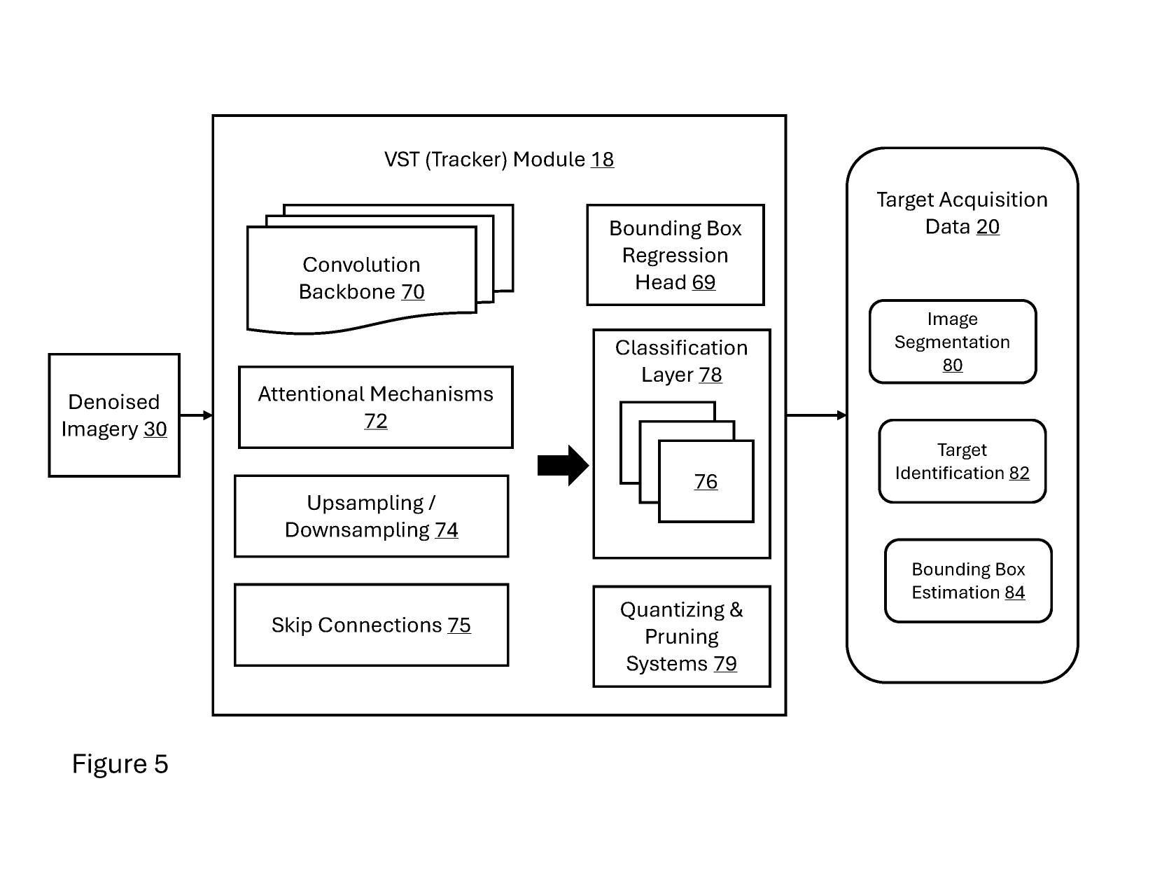

Once the denoised imagery is generated from the image enhancer 16, the denoised images 30 are inputted to VST (i.e., tracker) module 18 (FIG. 1), which outputs target acquisition data 20 (with remarkable efficiency). As shown in FIG. 5, VST module 18 integrates a set of architectural components tailored for the resource-constrained environment of FPGAs, thereby enabling reliable performance without penalties to accuracy or speed. VST module 18 is implemented via a multi-task machine learning architecture to perform image segmentation 80, object identification 82, and bounding box estimation 84 to comprehensively provide target acquisition data 20 from denoised SAR images. By extracting features using depth-wise separable convolutions and 1x1 convolutions via convolution backbone 70, applying spatial and channel attention mechanisms 72, and employing a specialized segmentation head with downsampling and upsampling 74, the VST module 18 generates precise segmentation masks (or segments) 76. These masks 76 isolate and classify targets, providing pixel-level localization. This detailed segmentation aids in accurate object detection and reduces false positives, significantly improving situational awareness and operational efficiency.

The VST module 18 architecture uses convolutional backbone 70 to employ depth-wise separable convolutions and 1x1 convolutions. In convolutional neural networks (CNNs), a convolution is a mathematical operation that extracts features from an input image by sliding a filter (also called a kernel) over the image and performing element-wise multiplication and summation at each location. This process creates a feature map that highlights the presence of specific patterns or features in the input image. Depth-wise separable convolutions decompose the standard convolution operation into spatial and depth-wise components, drastically reducing computational overhead while preserving feature extraction efficacy. The inclusion of 1x1 convolutions aids in dimensionality reduction and feature transformation, facilitating the efficient flow of information through the machine learning network. This convolutional backbone 70 forms the foundation for initial feature extraction from the input SAR imagery 12.

To enhance the system's ability to focus on critical features of an image, the VST module 18 incorporates advanced attentional mechanisms 72. Spatial attention layers selectively amplify regions of interest within the feature maps, effectively highlighting target areas while suppressing noise and irrelevant details. Concurrently, channel attention layers prioritize informative channels, refining the feature representation to ensure that the most relevant information is utilized for target acquisition. These attentional mechanisms 72 enhance the VST module's precision and reliability in diverse operational scenarios.

Recognizing the need for efficient downsampling and upsampling 74, the VST module 18 implements average pooling for downsampling, simplifying the implementation and reducing the computational complexity compared to maximum pooling. For upsampling, nearest neighbor interpolation may be used, providing a straightforward and resource-efficient method to restore spatial resolution in feature maps. These choices are guided by the constraints of FPGA hardware, allowing the VST module 18 to remain lightweight and efficient.

To maintain the integrity of spatial information throughout the machine learning network, skip connections 75 are integrated into the module. These connections directly concatenate feature maps from different stages, preserving essential details and enhancing the network's ability to learn hierarchical representations. Additionally, a feature fusion mechanism may be implemented to integrate multi-scale features, capturing both fine-grained and global information critical for accurate target detection and classification.

Furthermore, the VST module 18 includes a streamlined classification layer 78, which can be realized using fully connected layers and/or simplified convolutional layers. This layer is designed to be lightweight yet effective, facilitating the classification and localization of objects based on the extracted features. Finally, a bounding box regression head 69 of the VST module 18 performs the determination of the bounding box estimates of the object-of-interest for locating the target object in the image. The modular design ensures that this classification and regression component can be efficiently mapped onto FPGA hardware, improving performance in terms of latency and throughput.

The VST module 18 in addition may use quantization and pruning systems 79 to further enhance its suitability for FPGA deployment. Quantizing network weights and activations to lower precision significantly reduces memory usage and computational demands. Pruning redundant connections and parameters streamlines the machine learning network, enhancing both speed and efficiency without sacrificing performance. These strategies may allow the VST module to operate within the stringent constraints of FPGA environments.

The VST module 18, when implemented in embodiments of the disclosure, provides automated target acquisition data 20 in SAR imagery that is specifically tailored for FPGA deployment. The VST module architecture, combining simplified convolutional layers, attention mechanisms, and efficient pooling strategies, enables the VST module 18 and embodiments of the disclosure to meet the demands of real-time processing with accuracy and reliability. By integrating quantization and pruning techniques, the VST module 18 mitigates resource usage, making it a viable solution for diverse operational contexts.

Implementing the various embodiments discussed herein on FPGA or multi- processor system on a chip (MPSoC) platforms presents significant challenges due to resource constraints and may limit the use of large neural network architectures. The various modules and subcomponents discussed herein help to enable embodiments of the disclosure to efficiently utilize FPGA resources, achieving desired performance levels for real-time SAR imagery processing and ATA.

To facilitate the FPGA deployment, embodiments of the disclosure may adopt any of several deep compression approaches to reduce model size and computational complexity while maintaining performance. Embodiments of the disclosure may implement deep compression techniques, including: pruning, quantization, low-rank factorization, knowledge distillation, and/or hardware-aware neural architecture search (NAS).

Pruning involves removing redundant or less significant weights and neurons from a neural network, thereby reducing the number of parameters and computations required. This makes a model more efficient for FPGA deployment. Pruning techniques include: (i) Weight Pruning: Removing weights with small magnitudes, (ii) Neuron Pruning: Removing entire neurons or channels that contribute less to the final output, and (iii) Structured Pruning: Removing entire filters, layers, or blocks to simplify the model structure.

Quantization reduces the precision of weights and activations, e.g., from 32-bit floating-point to lower-bit representations like 8-bit integers (INT8). This decreases memory usage and accelerates computation on FPGAs. Known methodologies such as Quantization-Aware Training (i.e., incorporating quantization effects during training to maintain model accuracy) can further improve implementation in FPGA settings.

Low-rank factorization decomposes weight matrices into smaller matrices, reducing the number of parameters and computations. This is particularly effective for large, fully connected, and convolutional layers. Techniques include: (i) Singular Value Decomposition (SVD): Decomposing weight matrices into products of smaller matrices, and (ii) Tensor Decomposition: Decomposing multi-dimensional tensors used in convolutional layers.

Hardware-aware Neural Architecture Search (NAS) automatically searches for and improves neural network architectures specifically for FPGA constraints. This approach considers factors like latency, power consumption, and resource use during the architecture search process, resulting in models that are inherently efficient for FPGA deployment.

Embodiments of the disclosure provide various technical and commercial advantages, examples of which are discussed herein. By combining various types machine learning components with image enhancement techniques, embodiments of the disclosure provide a compact and deployable FPGA-based component to improve SAR imagery in a variety of operational settings. These and other benefits may arise from, e.g., the use of adversarial learning to reduce backscatter effects created by scattering nets in a particular environment, and by using spatial and channel attention layers with convolution operations to maintain persistent analysis and/or processing of certain objects in an environment. The results of such processing may be applicable over multiple frames of imaging and thus may improve a data set more widely by applying improvements to certain images to other, related images.

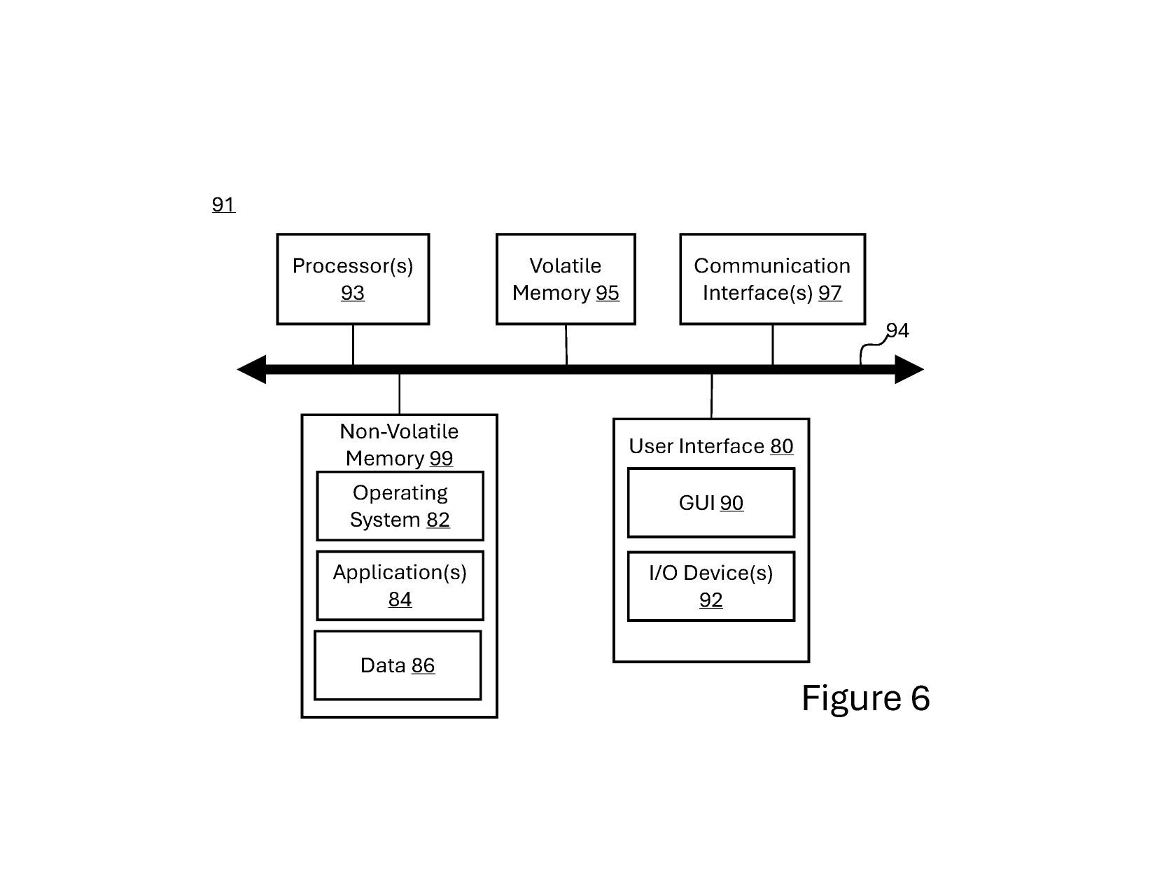

Elements of the described solution may be embodied in a computing system, such as that shown in FIG. 6 in which a computing device 91 may include one or more processors 93, volatile memory 95 (e.g., RAM), non-volatile memory 97 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 80, one or more communications interfaces 97, and communication bus 94. User interface 80 may include graphical user interface (GUI) 90 (e.g., a touchscreen, a display, etc.) and one or more input/output (I/O) devices 92 (e.g., a mouse, a keyboard, etc.). Non-volatile memory 99 stores operating system 82, one or more applications 84, and data 86 such that, for example, computer instructions of operating system 82 and/or applications 84 are executed by processor(s) 93 out of volatile memory 95. Data may be entered using an input device of GUI 90 or received from I/O device(s) 92. Various elements of computer 70 may communicate via communication bus 94. Computer 91 as shown in FIG. 6is shown merely as an example, as clients, servers and/or appliances and may be implemented by any computing or processing environment and with any type of machine or set of machines that may have suitable hardware and/or software capable of operating as described herein.

Processor(s) 93 may be implemented by one or more programmable processors executing one or more computer programs to perform the functions of the system. As used herein, the term "processor" describes an electronic circuit that performs a function, an operation, or a sequence of operations. The function, operation, or sequence of operations may be hard coded into the electronic circuit or soft coded by way of instructions held in a memory device. A "processor" may perform the function, operation, or sequence of operations using digital values or using analog signals. In some embodiments, the "processor" can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The "processor" may be analog, digital or mixed-signal. In some embodiments, the "processor" may be one or more physical processors or one or more "virtual" (e.g., remotely located or "cloud") processors. Communications interfaces may include one or more interfaces to enable a computer to access a computer network such as a LAN, a WAN, or the Internet through a variety of wired and/or wireless or cellular connections.

In described embodiments, a first computing device 91 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

What is claimed is:

1. A method comprising:
converting an input image into an enhanced image via an encoder-decoder network implemented with an adversarial learning system that is trained with real and synthetic imagery; and
identifying a target within the enhanced image by separating the enhanced image into a plurality of segments via a tracker module that includes a depth-wise convolution, a spatial attention mechanism and a channel attention mechanism.

2. The method of claim 1, wherein the encoder-decoder network includes an autoencoder network.

3. The method of claim 1, wherein the encoder-decoder network and the tracker module are implemented on a field programmable gate array (FPGA).

4. The method of claim 1, wherein the input image includes a synthetic aperture radar (SAR) image.

5. The method of claim 1, wherein the adversarial learning system includes:
a generator that generates synthetic imagery using convolutional layers; and
a discriminator that is trained to distinguish between synthetic imagery and real imagery, and provides feedback to the generator to improve synthetic imagery generation.

6. The method of claim 5, wherein the generator uses noise vectors to generate synthetic imagery.

7. The method of claim 5, wherein the synthetic imagery is utilized to train the encoder- decoder network.

8. The method of claim 1, wherein the tracker module is further utilized to a bounding box estimation.

9. The method of claim 1, wherein target and bounding box estimation are fed to a tracking module to track the target across a sequence of image frames.

10. The method of claim 1, wherein the tracker module implements one of pruning, quantization, and low-rank factorization to compress a model size of the enhanced image.

11. A system, comprising:
an encoder-decoder network configured to convert an input image into an enhanced image, wherein the encoder-decoder network is implemented with an adversarial learning system that is trained with real and synthetic imagery; and
a tracker module configured to receive the enhanced image and identify a target within the enhanced image by separating the enhanced image into a plurality of segments via a depth-wise convolution of the enhanced image, wherein the tracker module includes at least a spatial attention mechanism and a channel attention mechanism.

12. The system of claim 11, wherein the encoder-decoder network is an autoencoder network.

13. The system of claim 11, wherein the encoder-decoder network is communicatively coupled to the tracker module via a field programmable gate array (FPGA).

14. The system of claim 6, wherein the input image includes a synthetic aperture radar (SAR) image.

15. The system of claim 11, wherein the adversarial learning system includes:a generator that generates synthetic imagery using convolutional layers; and
a discriminator that is trained to distinguish between synthetic imagery and real imagery, and provides feedback to the generator to improve synthetic imagery generation.

16. The system of claim 15, wherein the generator uses noise vectors to generate synthetic imagery.

17. The system of claim 15, wherein the synthetic imagery is utilized to train the encoder- decoder network.

18. The system of claim 15, wherein the tracker module is further utilized to a bounding box estimation.

19. The system of claim 18, wherein target and bounding box estimation are fed to a tracking module to track the target across a sequence of image frames.

20. The system of claim 11, wherein the tracker module implements one of pruning, quantization, and low-rank factorization to compress a model size of the enhanced image.
